(19) United States
(12) Patent Application Publication
(10) Pub. No.: US 2024/0425173 A1
(43) Pub. Date: Dec. 26, 2024

(54) Disk Tuned Vibration Absorber

(71) Applicant: Textron Aviation Inc., Wichita, KS (US)

(72) Inventors: Gonzalo Eduardo Mendoza, Wichita, KS (US); Scott Alan Sanborn, Wichita, KS (US)

(21) Appl. No.: 18/748,974

(22) Filed: Jun. 20, 2024

Related U.S. Application Data
(60) Provisional application No. 63/510,349, filed on Jun. 26, 2023.

(51) Int. Cl. B64C 11/00; F16F 1/387

(52) U.S. Cl. CPC B64C 11/008; F16F 1/387

(57) ABSTRACT

Motorized aircraft and other mechanical constructs subject to a force vibrate at resonant frequencies, causing parts degradation, unpleasant sensations for occupants, unwanted noise, and other undesirable effects. Tuned vibration absorbers that mitigate these effects typically counteract vibrations at specific frequencies traveling in specific directions at specific locations within a given structure and are not adjustable. The present disclosure details a disk-shaped tuned vibration absorber that may be tuned on-the-spot within a structural mount such that the frequency at which the disk resonates may be varied and such that the working direction of the disk may be varied. The direction of vibration absorption of the disk may be altered by reconfiguring the disk within its mount, and the resonance of the disk may be altered by rotating an inner component of the disk. The inner component comprises a mass and an elastomer of circumferentially varying stiffness.

### CROSS-REFERENCE TO RELATED APPLICATIONS

This application claims the benefit of U.S. Provisional Application No. 63/510,349 entitled “Disk Tuned Vibration Absorber” and filed on Jun. 26, 2023, which is herein incorporated by reference in its entirety.

### BACKGROUND

### 1. Field

The disclosed embodiments relate generally to the field of structural vibration mitigation. More specifically, the disclosed embodiments are related to tuned vibration absorbers (TVAs) for propeller-driven aircraft.

### 2. Related Art

Many tuned vibration absorbers (TVAs) have been described in the prior art; however, these are generally tuned by manually adjusting spring tension, or by manually compressing an elastomer (O-rings, for example). Methods also exist for actively tuning a TVAs frequency, usually requiring electrical power to adjust the working frequency. U.S. Pat. No. 8,511,601 to Dandaroy et al. discloses an aircraft with tuned vibration absorbers mounted to the aircraft skin which are only tuned by changing the physical size and shape of the TVAs, or by changing the materials used in the mass and elastomeric component of the TVA. European Patent No. 1,463,894 to Davis discloses a tuned mass damper with adjustability by way of an adjusting screw resulting in the change of active coils in a coil spring that engages a damping mass. Non-patent article “Design of adjustable Tuned Mass Dampers using elastomeric O-rings” to Tang et al. (Journal of Sound and Vibration, 433. pp. 334-348) discloses a TVA with in-situ tunable frequency by way of compressing O-rings. Non-patent article “Characteristics of adjustable dynamic vibration absorber” to Nemoto et al. (J-STAGE, Vol. 84, Issue 862) discloses a TVA with a tunable frequency by way of manually adjusting spring constant.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages will be apparent from the following detailed description of the embodiments and the accompanying drawing figures.

In embodiments of the present disclosure, an adjustable frequency vibration reduction apparatus includes an outer frame configured to house an inner frame; an inner frame assembly disposed within the outer frame, wherein the inner frame assembly includes: an inner frame; an elastomeric material inside the inner frame; a mass inside the elastomeric material; and a bearing assembly inside the mass, wherein the bearing assembly is configured to enable rotation of the inner frame assembly within the outer frame; and at least one directional guide mechanically coupled to the bearing and the outer frame, wherein the outer frame is mounted to a structure, and rotation of the inner frame assembly is configured for adjusting a working frequency of the adjustable frequency vibration reduction apparatus.

In embodiments of the present disclosure, a vibration reduction system includes an elastomer-mass system with a circumferentially varying stiffness; an inner frame configured to house the elastomer-mass system; an outer frame configured to house the inner frame such that the inner frame is rotatable with respect to the outer frame; a set of directional guides secured to the outer frame, and a cap disposed on the inner frame and interfaced with the set of directional guides; wherein the inner frame is rotatable to adjust a working frequency of the elastomer-mass system relative to the directional guides.

### BRIEF DESCRIPTION OF THE SEVERAL VIEWS OF THE DRAWINGS

Illustrative embodiments are described in detail below with reference to the attached drawing figures, which are incorporated by reference herein and wherein:

FIG. 1 is a perspective view of a disk tuned vibration absorber with adjustable direction and frequency and a single directional guide, in an embodiment;

FIG. 2 is a perspective view of a disk tuned vibration absorber with adjustable direction and frequency and a dual directional guide, in another embodiment; and

FIG. 3 is a perspective view of a disk tuned vibration absorber with adjustable direction and frequency and a dual directional guide with circumferentially varying elastomers, in another embodiment; and

FIG. 4A is a perspective view of a disk tuned vibration absorber with adjustable direction and frequency, a dual directional guide with circumferentially varying elastomers, and a cylindrical variable mass assembly in another embodiment;

FIG. 4B is an exploded detail view of the cylindrical variable mass assembly, in an embodiment;

FIG. 5A shows of a disk tuned vibration absorber with a mount and a cap configured to be rotated to adjust a working frequency of the disk tuned vibration absorber, in an embodiment;

FIG. 5B is a side view of a disk tuned vibration absorber of FIG. 5A;

FIG. 6A shows a disk tuned vibration absorber with a mount and a removable cap disposed on the inner frame assembly, in an embodiment;

FIG. 6B shows the disk tuned vibration absorber of FIG. 6A with the cap removed;

FIG. 7A shows a disk tuned vibration absorber with a mount and a cap configured to be rotated to adjust the working frequency of the disk tuned vibration absorber, in an embodiment;

FIG. 7B is a side view of the disk tuned vibration absorber of FIG. 7A displaying a first mount configured to secure an inner frame and outer frame in position using a single pair of set screws;

FIG. 7C is a cutaway view of the disk tuned vibration absorber of FIG. 7B demonstrating an attachment system using set screws;

FIG. 7D is a side view of the disk tuned vibration absorber of FIG. 7C displaying a second mounting setup configured for using separate set screws;

FIG. 7E is a cutaway view of the disk tuned vibration absorber of FIG. 7D demonstrating an attachment system that secures an outer frame, and a mount in place relative to one another using two set screws;

FIG. 8A shows a disk tuned vibration absorber with a plurality of set screw slots configured in the base of the outer frame of the disk tuned vibration absorber for securing a mount to the disk tuned vibration absorber, in an embodiment; and

FIG. 8B is a side view of the disk tuned vibration absorber of FIG. 8A.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc., described in one embodiment may also be included in other embodiments, but is not necessarily included. Thus, the technology can include a variety of combinations and/or integrations of the embodiments described herein.

Forces acting on mechanical structures often produce unwanted vibrations in those structures, and excessive vibrations may lead to a reduction in product life or a perception of poor quality. Vibrations can also manifest in the form of undesirable noise or may be harsh, such as with vibrations an occupant may feel while seated in a moving vehicle. This vibration or noise may be due to an unbalanced rotating component, including components often found in motors, engines, pumps, or compressors. Vibration or noise may also be due to airborne pressure pulses from rotating blades, such as those from an aircraft propeller or helicopter rotor, or from a high structural transmissibility of a particular frequency.

Tuned vibration absorbers (TVAs) are widely used as an effective means to reduce such vibration and noise. TVAs are typically designed to resonate at a fixed frequency that counteracts a problem frequency in a structure. The TVA must be oriented to resonate in a particular direction corresponding to the direction of the problem vibration, and that direction is usually fixed by the TVA design and its mounting. The fixed direction is known as the working direction.

Such fixed designs will not perform optimally if structural compliance and/or vibration direction varies by location on the structure. For example, if the structural compliance/flexibility varies by location, a slightly different TVA resonant frequency may be required to obtain the desired results from mass damping at various locations. This would require more than one fixed TVA design, adding cost and complexity to a design or system. Likewise, if the direction of an offending vibration varies by location on a structure, more than one mounting scheme may be required for a TVA with fixed direction to perform optimally.

Embodiments disclosed herein provide a disk-shaped tuned vibration absorber with adjustable working direction and frequency. The disk-shaped tuned vibration absorber (hereinafter “TVA”) may be adjusted to provide absorption of a vibration throughout a range of directions and vibrational frequencies. This adjustability allows a single TVA design to be used in a variety of locations or for a variety of applications.

One main feature of the invention is a directional guide that is attached to an outer cylindrical ring, the outer ring being fixed into a mount. Another main feature of the invention is an inner frame assembly comprised of a frame, a mass, and an elastomer with the elastomer being bonded to the mass (forming an elastomer-mass system) and inner frame and the mass having a non-circular cross-section, or a circumferentially varying elastomer stiffness, or both. The working direction of the TVA is set by orienting the outer frame in a mount, such as a gimbal, such that a directional guide is aligned along the desired direction of mass motion, e.g., in the working direction.

The guide constrains the mass to a single degree of freedom movement as the guide comprises a proper stiffness configured to prevent movement in other degrees of freedom, including rotation and out-of-plane translation. With proper stiffness, the TVA is sufficiently rigid to resist out-of-plane motion and motion perpendicular to the guide while still being able to vibrate along the working direction of the device. The amount of mass, the shape of the mass, and the composition and distribution of the elastomer determine the working frequency range that may be achieved from a given TVA or a given elastomer-mass system. The working frequency is the frequency at which the TVA vibrates to absorb an incident vibration. If the mass is non-cylindrical in shape, the elastomer thickness in the radial direction will vary. Thus, the elastomer-mass system stiffness will vary circumferentially, resulting in a directionally dependent working frequency. Alternatively, if the mass is cylindrical in shape, the elastomer stiffness may be varied circumferentially by varying the elastomer composition, either continuously or in discrete steps, in order to achieve a directionally dependent working frequency. The working frequency of the TVA is set by rotating the inner frame assembly relative to the directional guide to provide a desired elastomer stiffness along the guide direction corresponding to the desired working frequency.

The inner frame assembly is prohibited from rotating once set to the desired position via a mechanical constraint such as a set screw or clamp. A variety of mounting methods and securing components in position relative to one another are possible. This method of frequency adjustability has two advantages. First, the system accounts for varying structural compliance at the mounting location, and second, the system accounts for manufacturing tolerances which affect the system frequency, such as the elastomer stiffness. In embodiments, the frequency response of the TVA can be adjusted by rotating the inner frame assembly while keeping the outer frame fixed. The inner frame may be rotated by means of a bearing. While the inner and outer frame are locked together, rotation of the assembly around its base adjusts the effective direction of absorption. In some embodiments, the mass within the inner frame may be comprised of concentric cylinders of varying mass, allowing for tuning of the frequency and overall effective mass through removal/addition of one or more inner cylinders, or the replacement of cylinders with those of a different mass.

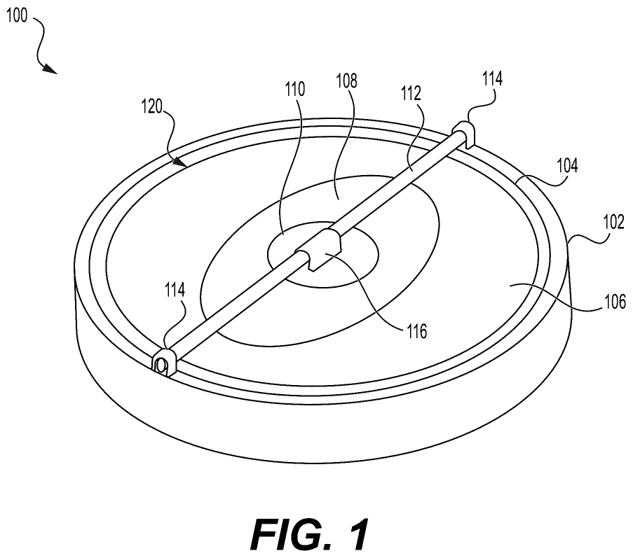

FIG. 1 shows a perspective view of a disk tuned vibration absorber 100 with adjustable direction and frequency and a single directional guide 112. A cylindrical fixed outer frame 102 houses a rotatable inner frame assembly 120 that comprises a cylindrical inner frame 104, an elastomer 106, a non-cylindrical mass 108, and a bearing 110. The inner frame 104 is affixed to the elastomer 106, which is in turn affixed to the mass 108, thereby forming an elastomer-mass system. The mass is rotatably coupled to the bearing 110. When not locked in place, the inner frame assembly 120 is free to rotate within the fixed outer frame 102 on the bearing 110, with its movement restricted in all other degrees of freedom by comprising a sufficient stiffness or being mechanically constrained. To mechanically constrain inner frame 104 relative to outer frame 102, the inner frame 104 and outer frame 102 may be locked in relative positions with respect to one another. For example, one or more radial set screws or pins may be inserted through the outer frame 104. An outer surface of the inner frame 104 may be configured with receptacles (e.g., dimples, holes, or threaded receptacles) positioned around a circumference of the inner frame 104, with each receptacle being configured to receive a set screw or pin. Alternatively, one or more clamps contacting both inner frame 104 and outer frames 102 may be used to prevent unwanted rotation of disk tuned vibration absorber 100 after the inner frame 104 is rotated to a desired orientation.

A directional guide 112 comprises a substantially linear member that passes through an attachment strap 116 rigidly fixed to the bearing 110 and is attached to the fixed outer frame 102 via attachment straps 114 to secure alignment of the bearing. In disk tuned vibration absorber 100, an inner race of bearing 110 and the outer frame 102 move together as the components are fixed to one another by directional guide 112. The mass 108 and outer race of the bearing 110 move together and are rotatable within the outer frame 102. Alternative attachment mechanisms may be employed in place of attachment straps 114, 116, such as bolted or pinned connections, welding or bonding, or various press-fit connections, without departing from the scope hereof.

Elastomer 106 may comprise a single elastomer material and comprises a varying radial thickness in disk tuned vibration absorber 100, leading to a circumferentially varying stiffness of inner frame assembly 120. Given the non-cylindrical shape of non-cylindrical mass 108, the radial stiffness of inner frame assembly 120 varies along the circumference of inner frame assembly 120. For instance, given an arc measured on inner frame assembly 120, the radial stiffness of inner frame assembly 120 may be different at each end of the arc. The radial stiffness may vary at all intervening positions between the ends of the arc such that inner frame assembly 120 comprises a circumferentially increasing, circumferentially decreasing, or otherwise circumferentially varying stiffness along the length of the arc. Thus, inner frame assembly 120 may vibrate at a range of working frequencies along the radial direction without replacement or modification of its constituent components.

Accordingly, the frequency response (or “working frequency”) of the disk tuned vibration absorber 100 is adjusted via rotation of the inner frame 104. To counteract the undesired effects of a vibration resonating at a problem frequency, disk tuned vibration absorber 100 may be mounted to a structure at an appropriate mounting point with directional guide 112 aligned with the working direction of the vibration. Inner frame 104 may then be rotated based on a stiffness of elastomer 106 and orientation/shape of mass 108 to vary the working frequency of disk tuned vibration absorber 100. Once inner frame 104 is set to a desired working frequency, as given by the alignment of inner frame 104 relative to directional guide 112, inner frame 104 may be secured in place relative to outer frame 102. When the vibration occurs, disk tuned vibration absorber 100 will dampen vibration of the structure to which disk tuned vibration absorber 100 is mounted, as elastomer 106 and mass 108 resonate with the problem frequency, thus reducing undesired structural vibration.

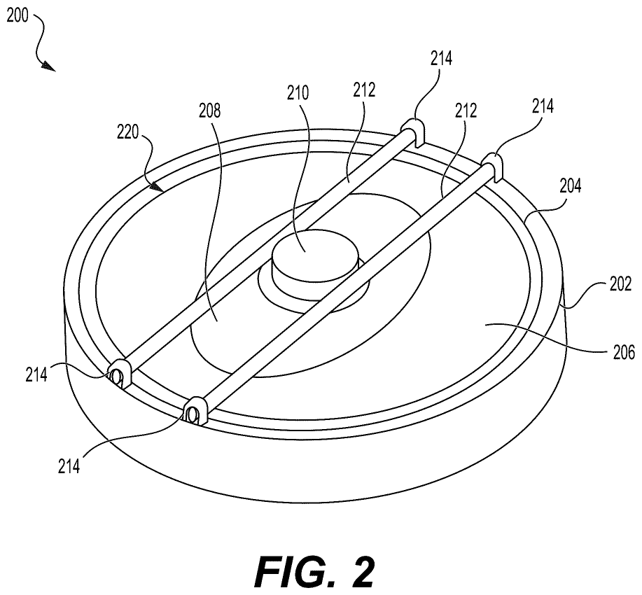

FIG. 2 shows a perspective view of a disk tuned vibration absorber 200 with adjustable direction and frequency and dual directional guides 212. A cylindrical fixed outer frame 202 houses a rotatable inner frame assembly 220 comprised of a cylindrical inner frame 204, an elastomer 206, a non-cylindrical mass 208, and a bearing 210 where the inner frame 204 is affixed to the elastomer 206, which is affixed to the mass 208, which is affixed to the bearing 210. The rotatable inner frame assembly 220 comprising the mass 208, elastomer 206, and inner frame 204 is rotatable within outer frame 202 via the bearing 210. In embodiments, bearing 210 is a plain bearing that enables rotation of mass 208 about the bearing 210. Alternatively, bearing 210 may be a non-rotatable element fixedly attached to mass 208 that abuts each of the directional guides 212 with a relatively low-friction interface. For example, bearing 210 may comprise a low friction cap that enables facile rotation of the rotatable inner frame assembly 220 with respect to the directional guides 212. Bearing 210 may in embodiments be an extension of mass 208 that extends upwards between the directional guides 212. The inner frame assembly 220 is free to rotate within the fixed outer frame 202, with all other degrees of freedom being restricted by the directional guides 212.

A pair of directional guides 212 comprising a set of two substantially parallel linear members tangentially pass either side of the bearing 210 and are attached to the fixed outer frame 202 via attachment straps 214. As similarly done with components of disk tuned vibration absorber 100, directional guides 212 may be aligned along the working direction of a vibration to be damped, and inner frame 204 is rotated such that the inner frame assembly 220 (i.e., the combination of mass 208 and elastomer 206) resonates at a frequency appropriate for damping the vibration (i.e., a working frequency).

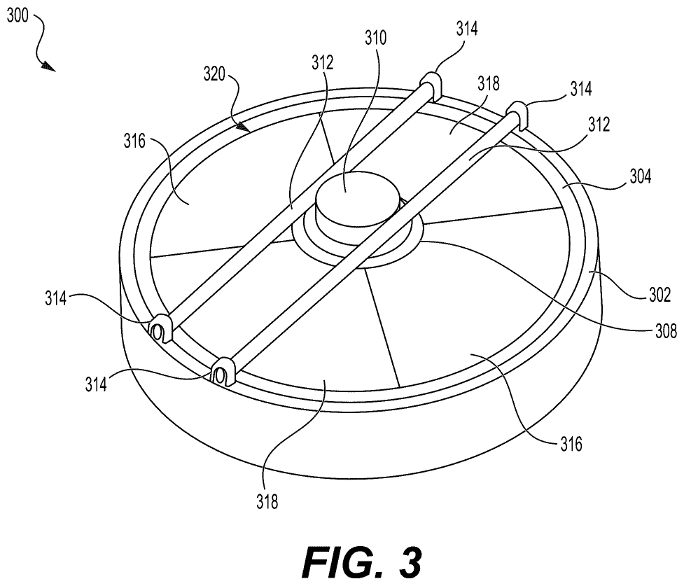

FIG. 3 shows a perspective view of a disk tuned vibration absorber 300 with adjustable direction and frequency and dual directional guides 312. A cylindrical fixed outer frame 302 houses a rotatable inner frame assembly 320, which comprises a cylindrical inner frame 304, circumferentially divided elastomers 316 and 318, a cylindrical mass 308, and a bearing 310. The inner frame 304 is affixed to the elastomers 316 and 318, which are affixed to the mass 308 which comprises the bearing 310. The arrangement is configured such that the inner frame assembly 320 is rotatable within the outer frame 302. The circumferentially divided elastomers 316 and 318 are of varying stiffnesses with a hard elastomer 316 being substantially stiffer than a soft elastomer 318. In certain embodiments, hard elastomer 316 has a Shore A durometer of about 70 while soft elastomer 318 has a Shore A durometer of about 20. In other embodiments, other elastomer materials may be used. The circumferentially divided elastomers may either be divided discretely, such that disk tuned vibration absorber 300 comprises distinct sections of elastomers 316 and 318, or an elastomer may comprise continually varying stiffness along the circumference of the assembly, as in disk tuned vibration absorber 100. A pair of directional guides 312 tangentially pass either side of the bearing 310 and are attached to the fixed outer frame 302 via attachment straps 314. The inner frame assembly 320 is free to rotate within the fixed outer frame 302, with all other degrees of freedom being restricted by the pair of directional guides 312.

The embodiment TVA demonstrated in FIG. 3 comprises an elastomer divided into discrete quarters with two quarters of hard elastomer 316 and two quarters of soft elastomer 318. Each quarter borders two quarters of the other elastomeric stiffness, and thus each quarter is positioned opposite the quarter of like elastomer. In alternate embodiments, the elastomeric stiffness may vary continuously, such as with a circumferentially decreasing elastomeric stiffness down to a minimum stiffness within the elastomer.

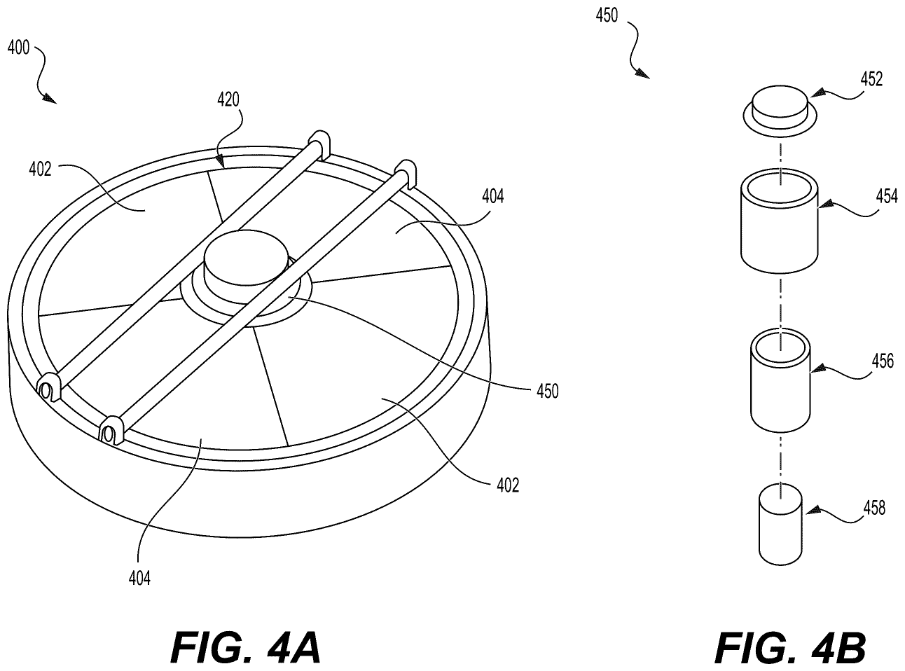

FIG. 4A shows a perspective view of a disk tuned vibration absorber 400 with adjustable direction and frequency, dual directional guides, and a cylindrical variable mass assembly 450. A cylindrical variable mass assembly 450 is affixed to elastomers 402 and 404.

FIG. 4B shows an exploded detail view of a cylindrical variable mass assembly 450 containing a bearing cap 452, an outer hollow effective mass 454, an inner hollow effective mass 456, and a solid effective mass 458. Such a bearing assembly may be used in any disk tuned vibration absorber 100, 200, 300, or 400. An alternative bearing cap 452 having an attachment strap (such as attachment strap 116 seen in FIG. 1) may be used in embodiments comprising a single directional guide affixed to the outer frame. In other embodiments, a bearing cap 452 may interface or abut a directional guide without being attached.

The outer hollow effective mass 454 is affixed to the elastomers 402 and 404. Each effective mass 454, 456, and 458 is appropriately sized to allow each mass to be inserted into each subsequent mass, leading to an arrangement of removable and/or interchangeable concentric masses. For example, the solid effective mass 458 can be inserted inside the inner hollow effective mass 456, which can then be inserted into the outer hollow effective mass 454. One method of tuning the frequency of the disk tuned vibration absorber 400 is by varying the mass of one or many of the effective masses 454, 456, or 458. This can be achieved, for example, by manufacturing each effective mass 454, 456, or 458 from a selection of different materials each having a different density.

For a given disk tuned vibration absorber 100, 200, 300, or 400, each of fixed outer frames 102, 202, or 302 may be attached via a mount such as a gimbal to the surface or structure where excessive vibrations are present. The directional guides 112, 212, or 312 are then aligned with the working direction of desired mass motion to counteract the problem frequency. The inner frame assembly 120, 220, 320, or 420 is then rotated, thus varying the working frequency of the TVA and effectively damping the problem vibrations. The TVA accomplishes this by comprising a rotatable elastomer-mass system, such that the inner frame 104, 204, 304 may be rotated to align a portion of appropriate stiffness of the elastomer-mass system with the directional guides. The inner frame assembly 120, 220, 320, or 420 is then mechanically locked in place relative to the fixed outer frame 102, 202, or 302 as described above for disk tuned vibration absorber 100.

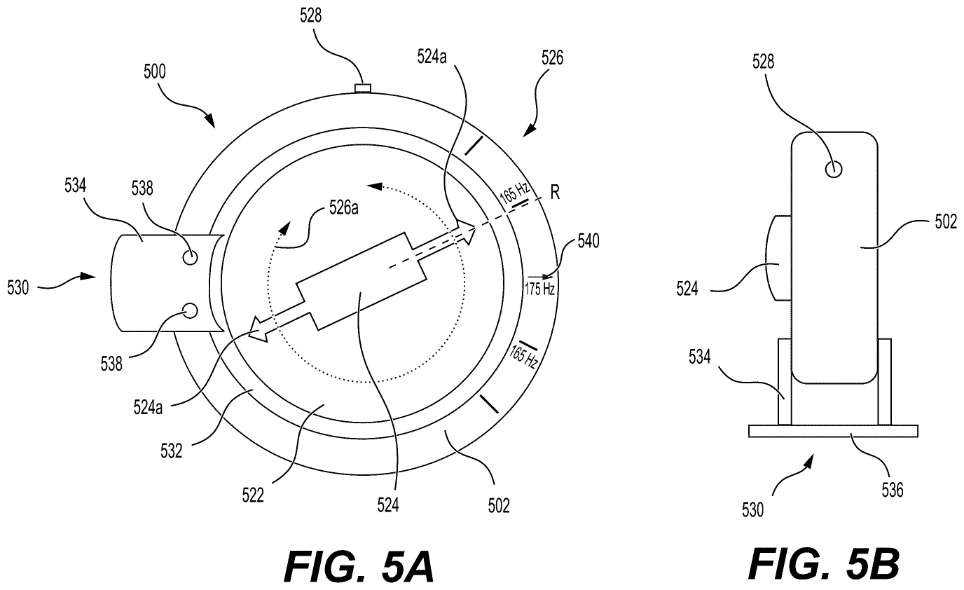

Referring now to FIGS. 5A and 5B, a disk tuned vibration absorber 500 may be configured in a mount 530. One example of disk tuned vibration absorber 500 is disk tuned vibration absorber 100 of FIG. 1 with a mount 530 and a disk cover 522 shown. However, disk tuned vibration absorber 500 may comprise a single directional guide 112 or dual directional guides 212 of FIG. 2 without departing from the scope hereof. Disk tuned vibration absorber 500 also comprises an outer frame 502 configured to partially enclose an inner frame (not shown) or configured as a shell around an inner frame. Mount 530 comprises a mounting bracket having connecting arms 534 and a mounting base 536. Mounting base 536 may be mechanically coupled to or within a structure (not shown). Mount 530 may be moved to different positions along the circumference of an outer frame 502 along orientation guide 532. Orientation guide 532 may comprise a groove, indentation, or receptacle bounding a portion of connecting arms 534 such that the orientation guide 532 provides a slide for the connecting arms 534. Connecting arms 534 may slide along orientation guide 532 to rotate mount 530 relative to outer frame 504. Once a desired orientation is reached such that a line-of-action indicator 540 on outer frame 502 is aligned with the direction of a vibration in a structure, a pair of set screws 538 may be tightened to secure outer frame 502 into position relative to mount 530.

A disk cover 522 may be disposed over an inner frame assembly (not shown) of disk tuned vibration absorber 500 in embodiments. A handle 524 disposed on disk cover 522 may be turned to rotate the inner frame assembly relative to outer frame 502, such that the working frequency of disk tuned vibration absorber 500 may be changed. Rotating handle 524 adjusts the orientation of the inner frame assembly relative to a directional guide similar to directional guide 112 of FIG. 1, and a graduated frequency scale 526 on the side of disk tuned vibration absorber 500 indicates example working frequencies at which the inner frame assembly may vibrate. Graduated frequency scale 526 may comprise a plurality of frequency labels (e.g., 165 Hz, 175 Hz, etc.) with associated degrees or other indicators indicating the working frequency achieved at that particular degree of rotation. Orientation indicators 524a may assist in more accurately setting the inner frame assembly to a desired working frequency. Arc 526a demonstrates possible directions of rotation for the inner frame assembly. An orientation line R is shown to demonstrate the alignment between handle 524 and graduated frequency scale 526, wherein in the embodiment shown, disk tuned vibration absorber 500 is set to vibrate at a working frequency of approximately 165 Hz. A line-of-action indicator 540 on graduated frequency scale 526 indicates the orientation of the directional guide (not shown) beneath disk cover 522. Once handle 524 is rotated to a desired working frequency as shown on graduated frequency scale 526, set screw 528 may be tightened to lock the inner frame in place relative to outer frame 502.

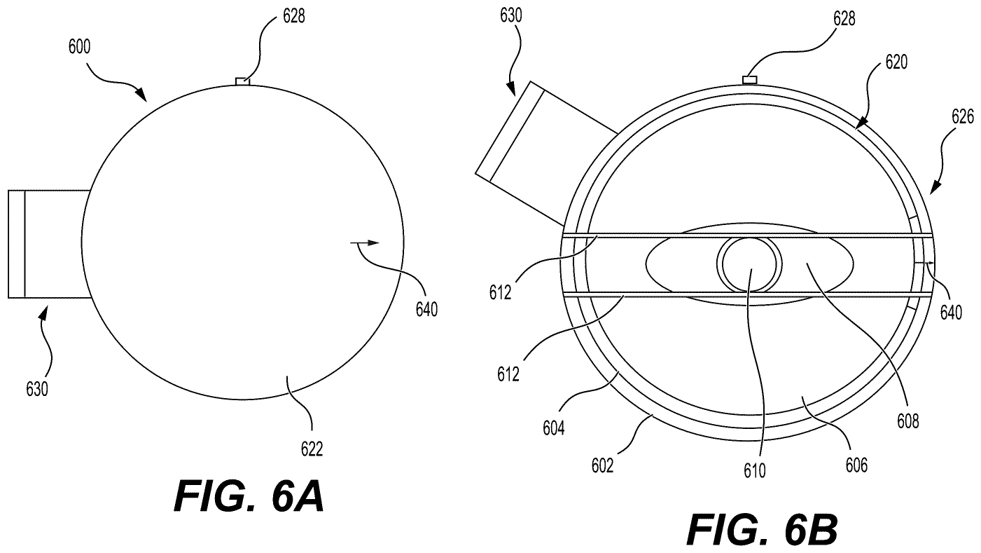

FIGS. 6A, 6B, 7A, 7B, 7C, 7D, 7E, 8A, and 8B are examples of disk tuned vibration absorber 200, 300, or 400 with alternate arrangements of some components. Certain components labeled in FIGS. 6A, 6B, 7A, 7B, 7C, 7D, 7E, 8A, and 8B are similar to those of FIGS. 5A and 5B, such as handle 524, mount 530, line-of-action indicator 540, etc. Unless otherwise discussed, their functions are substantially similar to their counterparts discussed alongside FIGS. 5A and 5B, and their descriptions are not repeated accordingly.

Referring now to FIGS. 6A and 6B, a lightweight disk tuned vibration absorber 600 comprises a disk cap 622 with a line-of-action indicator 640. Such a construction may reduce the size and mass of lightweight disk tuned vibration absorber 600 compared to other embodiments described herein, or components of disk tuned vibration absorber 600 may be fitted to a disk tuned vibration absorber 200, 300, or 400. Disk cap 622 may be configured to screw onto or snap onto outer frame 602. As may be seen in FIG. 6B, disk cap 622 is removed and inner frame assembly 620 of disk tuned vibration absorber 600 is visible. A graduated frequency scale 626 may be printed on inner frame 604, and inner frame 604 may be directly rotated such that a desired working frequency is set relative to line-of-action indicator 640 and directional guides 612. A mount 630 may be rigidly integrated with outer frame 602. Disk tuned vibration absorber 600 also comprises an elastomer 606, a non-cylindrical mass 608, a bearing cap 610, and a set screw 628.

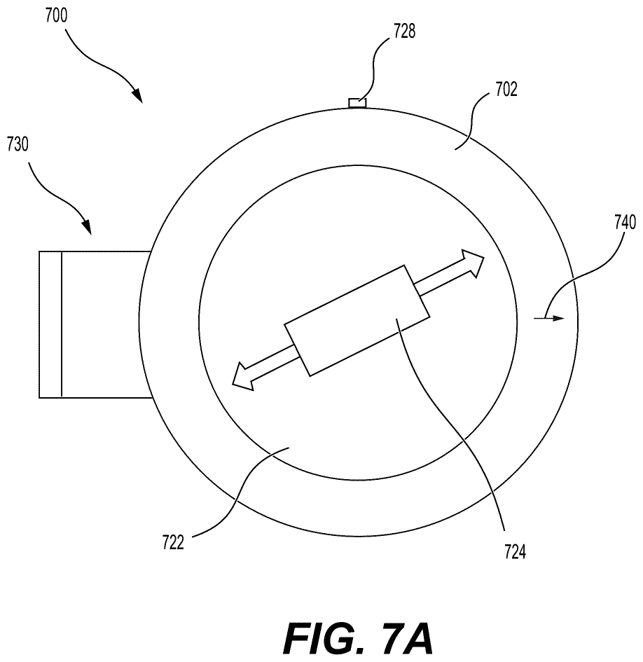

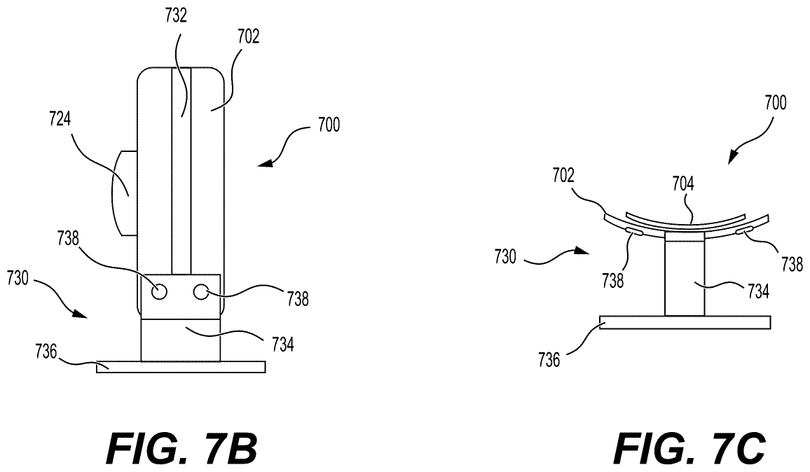

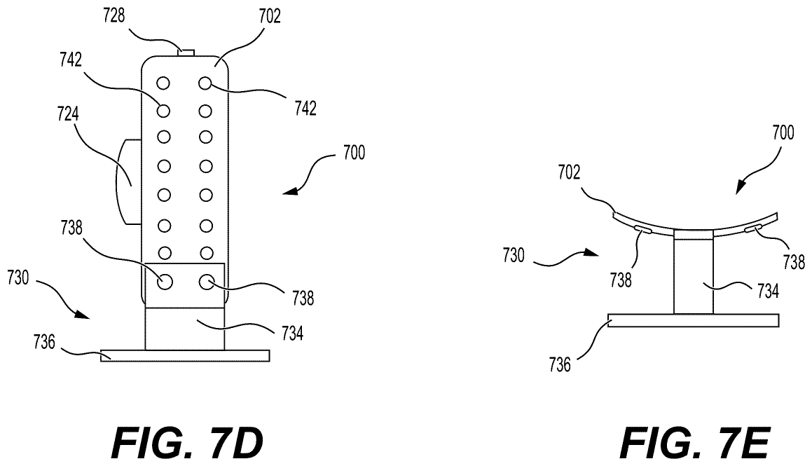

Referring now to FIGS. 7A, 7B, and 7C, a disk tuned vibration absorber 700 comprises an orientation guide 732 configured on an outer portion of an outer frame 702. FIG. 7C show a cutaway view on the edge of outer frame 702 to demonstrate the usage of set screws 738. In this embodiment, a pair of set screws 738 is configured to secure an inner frame (not shown) in position relative to outer frame 702. Independently, the pair of set screws 738 may be used to secure a mount 730 in position relative to outer frame 702. Disk tuned vibration absorber 700 also comprises a disk cap 722, a handle 724, a connecting arm 734, a mounting base 736, and a line-of-action 740.

Referring now to FIGS. 7A, 7D, and 7E, an alternate configuration of disk tuned vibration absorber 700 comprises a plurality of set screw slots 742 disposed at intervals along the sleeve of outer frame 704 configured on the sleeve of outer frame 704. FIG. 7E show a cutaway view on the edge of outer frame 702 to demonstrate the usage of set screws 738. In this embodiment, set screw 728 is configured to secure an inner frame (not shown) in position relative to outer frame 704 while set screws 738 are configured to secure mount 730 in position relative to outer frame 702 by tightening set screws 738 into a pair of set screw slots 742. Disk tuned vibration absorber 700C also comprises a disk cap 722, a handle 724, a connecting arm 734, a mounting base 736, and a line-of-action 740.

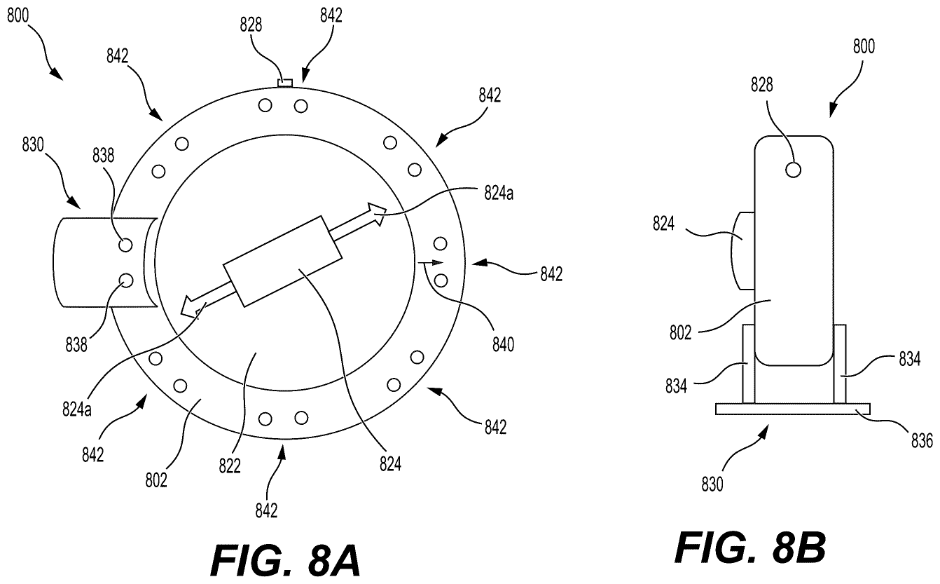

Referring now to FIGS. 8A and 8B, a disk tuned vibration absorber 800 comprises a plurality of set screw slots 842 disposed at intervals on along an outer frame 802. In this embodiment, set screw 828 is configured to secure an inner frame (not shown) in position relative to outer frame 802 while set screws 838 are configured to secure mount 830 in position relative to outer frame 802 by screwing set screw 838 into a pair of set screw slots 842. Disk tuned vibration absorber 800 also comprises disk cover 822, handle 824, orientation indicators 824a, connecting arms 834, mounting base 836, and line-of-action 840.

In any of the embodiments demonstrated in FIG. 5A, 5B, 6A, 6B, 7A, 7B, 7C, 7D, 7E, 8A, or 8B, a clamp, pin, or other means of rigid securement between two components (not shown) may be employed in place of any set screws. Usage of a clamp may be desirable to allow for a continuous range of working frequencies to be set, as opposed to restricting a disk tuned vibration absorber to operate only at working frequencies associated with discrete set screw slots.

Advantages of the disk tuned vibration absorbers 100, 200, 300, 400 with adjustable direction and frequency as described herein may be used local to the site of vibration absorption and tuned for vibration absorption at a specific frequency. Each TVA may be used to damp frequencies within a specific set of frequencies at which the TVA is configured to resonate. The presently disclosed TVA embodiments may be also used for troubleshooting problem vibrations by orienting the response direction until response is minimized in a complex structure, or as a common part within an assembly that can be installed in various different locations of a vehicle or system to minimize overall vibration levels acting in one or more frequencies or in different planes of orientation. A given TVA may be appropriate for use in multiple locations given the “on-the-fly” adjustability of each TVA.

Many different arrangements of the various components depicted, as well as components not shown, are possible without departing from the spirit and scope of what is claimed herein. Embodiments have been described with the intent to be illustrative rather than restrictive. Alternative embodiments will become apparent to those skilled in the art that do not depart from what is disclosed. A skilled artisan may develop alternative means of implementing the aforementioned improvements without departing from what is claimed.

It will be understood that certain features and subcombinations are of utility and may be employed without reference to other features and subcombinations and are contemplated within the scope of the claims. Not all steps listed in the various figures need be carried out in the specific order described.

The invention claimed is:

1. An adjustable frequency vibration reduction apparatus, comprising:
an outer frame configured to house an inner frame;
an inner frame assembly disposed within the outer frame, wherein the inner frame assembly comprises:
an inner frame;
an elastomeric material inside the inner frame;
a mass inside the elastomeric material; and
a bearing assembly inside the mass, wherein the bearing assembly is configured to enable rotation of the inner frame assembly within the outer frame; and
at least one directional guide mechanically coupled to the bearing and the outer frame,
wherein the outer frame is mounted to a structure, and rotation of the inner frame assembly is configured for adjusting a working frequency of the adjustable frequency vibration reduction apparatus.

2. The adjustable frequency vibration reduction apparatus of claim 1, wherein the mass comprises a cross-sectional shape that is different from a cross-sectional shape of the outer frame.

3. The adjustable frequency vibration reduction apparatus of claim 2, comprising a mass having a non-cylindrical cross-sectional shape configured around the bearing.

4. The adjustable frequency vibration reduction apparatus of claim 3, wherein the elastomeric material comprises a thickness that varies in a circumferential direction.

5. The adjustable frequency vibration reduction apparatus of claim 1, wherein the mass comprises a cylindrical cross-sectional shape and the elastomeric material comprises a plurality of sections having elastomers of different stiffness, such that the elastomeric material provides a working frequency that varies based on a directional arrangement of the sections.

6. The adjustable frequency vibration reduction apparatus of claim 1, wherein the mass comprises a cylindrical cross-sectional shape and the elastomeric material comprises an elastomer having a circumferentially decreasing stiffness.

7. The adjustable frequency vibration reduction apparatus of claim 1, wherein the mass comprises a set of concentric interchangeable cylindrical masses configured to enable adjustment of the overall mass of the adjustable frequency vibration reduction apparatus.

8. The adjustable frequency vibration reduction apparatus of claim 1, comprising a mount configured on the outer frame for rigidly mounting the outer frame to a structure.

9. The adjustable frequency vibration reduction apparatus of claim 1, comprising a removable disk cap over the inner frame configured to rotate the inner frame assembly.

10. The adjustable frequency vibration reduction apparatus of claim 1, comprising a plurality of set screws configured to secure the inner frame assembly in place relative to the outer frame or to secure the outer frame assembly in place relative to the mount.

11. A vibration reduction system, comprising:
an elastomer-mass system with a circumferentially varying stiffness;
an inner frame configured to house the elastomer-mass system;
an outer frame configured to house the inner frame such that the inner frame is rotatable with respect to the outer frame;
a set of directional guides secured to the outer frame, and
a cap disposed on the inner frame and interfaced with the set of directional guides;
wherein the inner frame is rotatable to adjust a working frequency of the elastomer-mass system relative to the directional guides.

12. The vibration reduction system of claim 11, wherein the set of directional guides comprises two parallel members each secured to the outer frame and configured to set a working direction of the vibration reduction system with respect to a structure.

13. The vibration reduction system of claim 11, comprising a cap extending from the inner frame, wherein the cap is configured for rotating within the directional guide.

14. The vibration reduction system of claim 11, wherein the elastomer-mass system comprises a non-cylindrical mass disposed within an elastomeric material of circumferentially varying thickness.

15. The vibration reduction system of claim 11, wherein the elastomer-mass system comprises a cylindrical mass disposed within an elastomeric material of circumferentially varying stiffness.

16. The vibration reduction system of claim 15, wherein the elastomeric material comprises a first section having a first stiffness and a second section having a second stiffness, the first stiffness being substantially different than the second stiffness.

17. The vibration reduction system of claim 11, wherein the elastomer-mass system comprises a set of interchangeable concentric masses configured to adjust the mass of the elastomer-mass system.

18. The vibration reduction system of claim 11, comprising a removable disk cap covering the inner frame wherein the disk cap is configured to rotate the inner frame.

19. The vibration reduction system of claim 11, comprising a set screw or clamp configured to secure the inner frame in place relative to the outer frame and set of directional guides.

20. The vibration reduction system of claim 19, wherein the outer frame is rotatable relative to a mount to adjust the orientation of the outer frame and the directional guide relative to the mount, and wherein the outer frame comprises a plurality of set screws or a clamp for securing the outer frame in place relative to the clamp.
